(19) United States
(12) Patent Application Publication
(10) Pub. No.: US 2022/0153990 A1
(43) Pub. Date: May 19, 2022

(54) POLYCARBONATE RESIN COMPOSITION, METHOD FOR PRODUCING THE SAME, MASTERBATCH PELLET, AND MOLDED BODY

(71) Applicants: Ube Material Industries, Ltd., Ube-shi, Yamaguchi (JP); NATIONAL UNIVERSITY CORPORATION YAMAGATA UNIVERSITY, Yamagata-shi, Yamagata (JP)

(72) Inventors: Tetsuo Takayama, Yonezawa-shi (JP); Yuzo Kato, Ube-shi (JP); Toru Inagaki, Ube-shi (JP)

(73) Assignees: Ube Material Industries, Ltd., Ube-shi, Yamaguchi (JP); NATIONAL UNIVERSITY CORPORATION YAMAGATA UNIVERSITY, Yamagata-shi, Yamagata (JP)

(21) Appl. No.: 17/440,305

(22) PCT Filed: Mar. 17, 2020
(86) PCT No.: PCT/JP2020/011738

§ 371 Date: Sep. 17, 2021

(30) Foreign Application Priority Data
Mar. 18, 2019 (JP) 2019-050116

(51) Int. Cl. C08L 69/00; C08J 3/22

(52) U.S. Cl. CPC C08L 69/00; C08J 3/22; C08J 2425/08; C08J 2455/02; C08J 2369/00

(57) ABSTRACT

A polycarbonate resin composition includes: 50 to 90% by mass of polycarbonate resin (A); 2 to 30% by mass of acrylonitrile-butadiene-styrene copolymer resin (B); 5 to 40% by mass of at least one basic magnesium sulfate (C) selected from fibrous basic magnesium sulfate (C-1) and fan-shaped basic magnesium sulfate (C-2); 0.1 to 8% by mass of at least one (D) selected from a fatty acid metal salt and a fatty acid; and 1 to 20% by mass of elastomer (E).

### TECHNICAL FIELD

The present invention relates to a polycarbonate resin composition, a method for producing the same, masterbatch pellets, and a molded body.

### BACKGROUND ART

Polycarbonate resins have excellent mechanical properties and thermal properties, and are therefore widely used in various fields such as OA equipment, electronic and electrical equipment, and automobiles. However, the polycarbonate resin has poor processability due to its high melt viscosity, and is inferior in chemical resistance because of being a non-crystalline resin. Therefore, it is known to add a polyolefin resin to the polycarbonate resin in order to improve the chemical resistance of the polycarbonate resin. Many resin compositions to which a compatibilizer such as an elastomer or a filler is added have been proposed in order to enhance the compatibility between the two having different properties and to impart practical mechanical properties.

For example, Patent Literature 1 has disclosed a technique for adding a glass fiber as an inorganic filler to a resin composition containing a polycarbonate resin, a styrene-based resin, and thermoplastic elastomer in order to obtain a molded body for OA equipment parts with excellent vibration-damping properties without impairing the properties of polycarbonate-based resin.

### CITATION LIST

### Patent Literature

Patent Literature 1: JP 2000-7904 A

### SUMMARY OF INVENTION

### Technical Problem

However, a molded body obtained by curing a polycarbonate resin composition containing glass fibers has insufficient impact strength. In addition, glass fibers generally used have a large fiber diameter, and thus the appearance of the molded body may be impaired.

Therefore, fibrous basic magnesium sulfate has been attracting attention as a filler having a smaller fiber diameter than glass fiber, having a reinforcing effect, that can provide the molded body having an excellent appearance. Fibrous basic magnesium sulfate is a biosoluble and safe filler. However, fibrous basic magnesium sulfate is weakly basic, and if it is added to a polycarbonate resin that is weak against a base, thereby hydrolyzing the polycarbonate resin. This case causes a problem of kneading itself being impossible.

Therefore, an object of the present invention is to provide a polycarbonate resin composition that can be kneaded and molded without hydrolysis, has excellent processability, and can obtain a molded product having good mechanical properties and appearance, a method for producing the same, masterbatch pellets, and a molded body.

### Solution to Problem

As a result of intensive investigations to achieve the above object, the present inventors have found that even when fibrous basic magnesium sulfate is added to the polycarbonate resin, kneading is possible without hydrolysis of the polycarbonate resin and the processability is also improved by containing an acrylonitrile-butadiene-styrene copolymer resin, at least one selected from a fatty acid metal salt and a fatty acid, and an elastomer at predetermined ratios. Thus, the present invention has been completed.

That is, the present invention relates to a polycarbonate resin composition including: 50 to 90% by mass of polycarbonate resin (A); 2 to 30% by mass of acrylonitrile-butadiene-styrene copolymer resin (B); 5 to 40% by mass of at least one basic magnesium sulfate (C) selected from fibrous basic magnesium sulfate (C-1) and fan-shaped basic magnesium sulfate (C-2); 0.1 to 8% by mass of at least one (D) selected from a fatty acid metal salt and a fatty acid; and 1 to 20% by mass of elastomer (E).

In addition, the present invention relates to a method for producing a polycarbonate resin composition, the method including: a first step of melt-kneading 2 to 50% by mass of acrylonitrile-butadiene-styrene copolymer resin (B), 40 to 70% by mass of at least one basic magnesium sulfate (C) selected from fibrous basic magnesium sulfate (C-1) and fan-shaped basic magnesium sulfate (C-2), 0.1 to 5% by mass of at least one (D) selected from a fatty acid metal salt and a fatty acid, and 1 to 50% by mass of elastomer (E) to obtain masterbatch pellets; and a second step of melt-kneading 10 to 60% by mass of the masterbatch pellets and 40 to 90% by mass of polycarbonate resin (A) to produce a polycarbonate resin composition.

Moreover, the present invention is masterbatch pellets for producing a polycarbonate resin composition by kneading with a diluent including polycarbonate resin (A), the masterbatch pellets including 2 to 50% by mass of acrylonitrile-butadiene-styrene copolymer resin (B), 40 to 70% by mass of at least one basic magnesium sulfate (C) selected from fibrous basic magnesium sulfate (C-1) and fan-shaped basic magnesium sulfate (C-2), 0.1 to 5% by mass of at least one (D) selected from a fatty acid metal salt and a fatty acid, and 1 to 50% by mass of elastomer (E).

In addition, the present invention relates to a molded body, which is a molded product of the polycarbonate resin composition.

### Advantageous Effects of Invention

The present invention can provide a polycarbonate resin composition that can be kneaded and molded without hydrolysis, has excellent processability, and can obtain a molded body having good mechanical properties and appearance, a method for producing the same, masterbatch pellets, and a molded body.

### DESCRIPTION OF EMBODIMENTS

### 1. Polycarbonate Resin Composition

The polycarbonate resin composition of the present invention includes: 50 to 90% by mass of polycarbonate resin (A); 2 to 30% by mass of acrylonitrile-butadiene-styrene copolymer resin (hereinafter, also referred to as ABS resin) (B); 5 to 40% by mass of at least one basic magnesium sulfate (C) selected from fibrous basic magnesium sulfate (C-1) and fan-shaped basic magnesium sulfate (C-2); 0.1 to 8% by mass of at least one (D) selected from a fatty acid metal salt and a fatty acid; and 1 to 20% by mass of elastomer (E).

The polycarbonate resin and the ABS resin have affinity, and therefore these are mixed and dispersed. This is presumed to be one factor that suppresses hydrolysis of the polycarbonate resin. That is, in the polycarbonate resin composition of the present invention, an interface is generated between the ABS resin and basic magnesium sulfate, and interfacial tension related to mutual cohesive force is generated at the interface. The attractive force acts to localize the elastomer at the interface, thereby avoiding direct contact of basic magnesium sulfate with the polycarbonate resin. It is considered that the above result allows the polycarbonate resin composition to be kneaded and molded without hydrolysis of the polycarbonate resin. Hereinafter, each component will be described.

### (A) Polycarbonate Resin

The polycarbonate resin is not particularly limited, and for example, aliphatic polycarbonate and aromatic polycarbonate can be used. Of these, aromatic polycarbonate is preferable. A commercially available product may be used as the polycarbonate resin, or a synthetic resin may be used as appropriate.

The method for synthesizing the polycarbonate resin is not particularly limited and may be appropriately selected depending on the intended purpose. Examples thereof include a method of synthesizing a divalent phenol and a carbonate precursor by a solution method or a melting method. In addition, for example, a molecular weight modifier, a branching agent, a catalyst may be appropriately used as necessary.

Examples of the divalent phenol include bisphenol A [2,2-bis(4-hydroxyphenyl)propane], hydroquinone, 2,2-bis(4-hydroxyphenyl)pentane, 2,4′-dihydroxydiphenylmethane, bis(2-hydroxyphenyl)methane, bis(4-hydroxyphenyl)methane, bis(4-hydroxy-5-nitrophenyl)methane, 1,1-bis(4-hydroxyphenyl)ethane, 3,3-bis(4-hydroxydiphenyl)pentane, 2,2′-dihydroxydiphenyl, 4,4′-dihydroxydiphenyl, 2,6-dihydroxynaphthalene, bis(4-hydroxyphenyl)sulfone, bis(3,5-diethyl-4-hydroxyphenyl)sulfone, 2,2-bis(3,5-dimethyl-4-hydroxyphenyl)propane, 2,4′-dihydroxydiphenylsulfone, 5′-chloro-2,4′-dihydroxydiphenylsulfone, bis(4-hydroxyphenyl)diphenyl ether, 4,4′-dihydroxy-3,3′-dichlorophenylether, 4,4′-dihydroxy-2,5-dichlorodiphenylether, bis(4-dihydroxy-5-propylphenyl)methane, bis(4-dihydroxy-2,6-dimethyl-3-methoxyphenyl)methane, 1,1-bis(4-hydroxy-2-ethylphenyl)ethane, 2,2-bis(3-phenyl-4-hydroxyphenyl)propane, bis(4-hydroxyphenyl)cyclohexylmethane, and 2,2-bis(4-hydroxyphenyl)-1-phenylpropane. These may be used singly or in combination of two or more. Of these, bis(4-hydroxyphenyl)alkane-based compounds are preferable, and bisphenol A is particularly preferable, from the viewpoint of easy availability on the market.

The carbonate precursor is not particularly limited and can be appropriately selected depending on the intended purpose. Examples thereof include carbonyl halide, carbonate, and haloformate. Specific examples thereof include phosgene, diphenyl carbonate, dihaloformate of divalent phenol, and mixtures thereof.

The melt flow rate (MFR) of the polycarbonate resin can be appropriately selected depending on the intended purpose, but is preferably 2 to 25 g/10 minutes, and more preferably 2 to 10 g/10 minutes. When the melt flow rate of the polycarbonate resin is 2 g/10 minutes or more, a polycarbonate resin composition having good molding processability can be obtained. In addition, when the melt flow rate is 25 g/10 minutes or less, sufficient impact strength can be imparted to the molded body.

The content of the polycarbonate resin is in the range of 50 to 90% by mass, and preferably 55 to 75% by mass, with respect to the total amount of the polycarbonate resin composition. When the content of the polycarbonate resin is 50% by mass or more, a molded body having high impact strength derived from the polycarbonate resin can be obtained. Whereas, when the content of the polycarbonate resin is 90% by mass or less, the reinforcing effect of the filler can be sufficiently exhibited and a desired flexural modulus can be imparted to the molded body.

### (B) Acrylonitrile-Butadiene-Styrene Copolymer Resin (ABS Resin)

The ABS resin may be a resin obtained by either a grafting method or a polymer blending method. The composition of the ABS resin is not particularly limited, and is generally about 5 to 50% of acrylonitrile, 5 to 40% of butadiene, and 95 to 50% of styrene.

The ABS resin may be used singly or in combination of two or more. The melt flow rate (MFR) of the ABS resin can be appropriately selected depending on the intended purpose, but is preferably 5 to 60 g/10 minutes, and more preferably 10 to 60 g/10 minutes.

The content of the ABS resin is in the range of 2.0 to 30% by mass, preferably in the range of 2 to 25% by mass, and more preferably in the range of 5 to 20% by mass, with respect to the total amount of the polycarbonate resin composition. When the content of the ABS resin is 2.0% by mass or more, hydrolysis of the polycarbonate resin by basic magnesium sulfate can be suppressed. Whereas, when the content of the ABS resin is 20% by mass or less, a molded body having a desired impact strength can be obtained. In addition, from the viewpoint of suppressing hydrolysis of the polycarbonate resin, the ratio of the ABS resin to basic magnesium sulfate (ABS resin/basic magnesium sulfate) is desirably 0.4 to 1.0.

### (C) Basic Magnesium Sulfate

The basic magnesium sulfate can be obtained by hydrothermal synthesis with, for example, magnesium hydroxide and magnesium sulfate, as raw materials, produced from seawater. As the basic magnesium sulfate, either fibrous basic magnesium sulfate or fan-shaped basic magnesium sulfate may be used, but fibrous basic magnesium sulfate is particularly preferable.

(C-1) Fibrous Basic Magnesium Sulfate

The average major axis of the fibrous basic magnesium sulfate is generally in the range of 5 to 100 μm, preferably in the range of 10 to 60 μm. In addition, the average minor axis of the fibrous basic magnesium sulfate is generally in the range of 0.1 to 5.0 μm, preferably in the range of 0.2 to 2.0 μm, and particularly preferably in the range of 0.2 to 1.0 μm.

Conventionally, the glass fiber used as a filler has an average fiber diameter (average minor axis) of about 10 μm at the minimum. Fibrous basic magnesium sulfate has a smaller average fiber diameter (average minor axis) than glass fiber, and therefore has a smoother appearance than glass fiber.

The fibrous basic magnesium sulfate generally has an average aspect ratio (average major axis/average minor axis) of 2 or more, preferably 5 or more, and particularly preferably in the range of 5 to 80. The average major axis and average minor axis of fibrous basic magnesium sulfate can be calculated from the average values of the major axis and minor axis of 100 pieces of particles measured from a magnified image by a scanning electron microscope (SEM). In addition, the fibrous basic magnesium sulfate may be an aggregate or a conjugate of a plurality of fibrous particles.

(C-2) Fan-Shaped Basic Magnesium Sulfate

Fan-shaped basic magnesium sulfate is particles obtained by joining and connecting a part of a plurality of fibrous basic magnesium sulfates in a fan shape, and for example, the average particle length is 2 to 100 μm, the average particle width is 1 to 40 μm, and the average aspect ratio is about 1 to 100. Herein, the average particle length refers to the dimension in the longitudinal direction of the particles, and the average particle width refers to the maximum dimension in the short direction of the particles. The longitudinal direction of the particles is the direction in which the particle length is maximized, and the short direction of the particles is the direction orthogonal to the longitudinal direction. In addition, the average aspect ratio is a ratio (average particle length/average particle diameter).

Each fibrous basic magnesium sulfate constituting the fan-shaped basic magnesium sulfate has an average fiber length of 2 to 100 μm, an average fiber diameter of 0.1 to 5 μm, and an average aspect ratio of 1 to 1000. The plurality of fibrous basic magnesium sulfates are bundled at one end and spread at the other end, for example. In addition, the plurality of fibrous basic magnesium sulfates may be bundled at arbitrary positions in the longitudinal direction and be spread at both ends. Such a fan-shaped basic magnesium sulfate can be produced and confirmed according to the methods described in, for example, JP 4-36092 B and JP 6-99147 B.

In addition, the fan-shaped basic magnesium sulfate does not necessarily have to be in a state in which individual fibrous basic magnesium sulfates are confirmed, and in some cases, fibrous basic magnesium sulfates may be bonded to each other in the longitudinal direction. When the fibrous basic magnesium sulfate having the above shape and further having an average fiber length, an average fiber diameter, and an average aspect ratio in a predetermined range is confirmed to be included, this can be regarded as the fan-shaped basic magnesium sulfate used in the present invention.

The content of the basic magnesium sulfate is in the range of 5 to 40% by mass, preferably in the range of 5 to 30% by mass, and more preferably in the range of 10 to 20% by mass, with respect to the total amount of the polycarbonate resin composition. When the content of the basic magnesium sulfate is 5% by mass or more, the reinforcing effect of the basic magnesium sulfate is exhibited, and a desired flexural modulus can be imparted to the molded body. Whereas, when the content of basic magnesium sulfate is 40% by mass or less, a polycarbonate resin composition having good processability can be obtained.

### (D) Fatty Acid Metal Salts and Fatty Acids

The polycarbonate resin composition of the present invention contains at least one selected from a fatty acid metal salt and a fatty acid, and thereby basic magnesium sulfate is distributed well in the resin.

The fatty acid preferably has a carbon atom number in the range of 12 to 22, and may be a saturated fatty acid or an unsaturated fatty acid. Examples of the saturated fatty acid include lauric acid, tridecylic acid, myristic acid, pentadecylic acid, palmitic acid, margaric acid, stearic acid, nonadecylic acid, arachidic acid, and behenic acid. Examples of the unsaturated fatty acid include myristoleic acid, palmitoleic acid, oleic acid, elaidic acid, vaccenic acid, gadoleic acid, and erucic acid. Examples of the metal salt include magnesium salt, calcium salt, aluminum salt, lithium salt, and zinc salt. Particularly, at least one selected from the group consisting of magnesium stearate, calcium stearate, and aluminum stearate is preferable.

The contents of the fatty acid metal salt and the fatty acid are in the range of 0.1 to 8% by mass, preferably in the range of 0.1 to 7% by mass, and more preferably in the range of 0.5 to 6% by mass, with respect to the total amount of the polycarbonate resin composition. When the contents of the fatty acid metal salt and the fatty acid are 0.1% by mass or more, the effect of adding these compounds is exhibited. Whereas, when the contents of the fatty acid metal salt and the fatty acid are 8% by mass or less, a polycarbonate resin composition having good thermal stability can be obtained. At least one of a fatty acid metal salt and a fatty acid may be contained in the polycarbonate resin composition, and the fatty acid metal salt is particularly preferable.

### (E) Elastomer

A styrene-based thermoplastic elastomer is preferably used as the elastomer. The styrene-based thermoplastic elastomer is preferably a block copolymer represented by the following formula (e1) or (e2).

Xk−Ym−Xn (e1)

Xm−Yn (e2)

In the above formula, X represents an aromatic vinyl polymer block. In the formula (e1), the degree of polymerization may be the same or different at both ends of the molecular chain. In addition, Y is selected from a butadiene polymer block, an isoprene polymer block, a butadiene/isoprene copolymer block, a hydrogenated butadiene polymer block, a hydrogenated isoprene polymer block, a hydrogenated butadiene/isoprene copolymer block, a partially hydrogenated butadiene polymer block, a partially hydrogenated isoprene polymer block, and a partially hydrogenated butadiene/isoprene copolymer block. k, m, and n are integers of 1 or more.

Specific examples thereof include styrene-ethylene/butylene-styrene copolymer, styrene-ethylene/propylene-styrene copolymer, styrene-ethylene/ethylene/propylene-styrene copolymer, styrene-butadiene-butene-styrene copolymer, styrene-butadiene-styrene copolymer, styrene-isoprene-styrene copolymer, styrene-hydrogenated butadiene diblock copolymer, styrene-hydrogenated isoprene diblock copolymer, styrene-butadiene diblock copolymer, and styrene-isoprene diblock copolymer, and of these, styrene-ethylene/butylene-styrene copolymer, styrene-ethylene/propylene-styrene copolymer, styrene-ethylene/ethylene/propylene-styrene copolymer, and styrene-butadiene-butene-styrene copolymer are most preferable.

The content of the X component in the block copolymer is 40 to 80% by mass, preferably 40 to 75% by mass, and more preferably 40 to 70% by mass. When the content of the X component is 40% by mass or more, appropriate rigidity and impact strength can be imparted to the molded body. Whereas, when the X component is 80% by mass or less, a molded body having a desired impact strength can be obtained.

The weight average molecular weight of the styrene-based thermoplastic elastomer is preferably 250000 or less, more preferably 200000 or less, and still more preferably 150000 or less. When the weight average molecular weight is 250000 or less, there is no possibility of lower molding processability or deteriorated dispersibility in the polycarbonate resin composition. In addition, the lower limit of the weight average molecular weight is not particularly limited, but is preferably 40000 or more, and more preferably 50000 or more.

The weight average molecular weight is a value measured by the following method. That is, the molecular weight is measured in terms of polystyrene by a gel permeation chromatograph, and the weight average molecular weight is calculated. The melt flow rate (230° C., 2.16 kg) of the styrene-based thermoplastic elastomer is preferably 0.1 to 10 g/10 min, more preferably 0.15 to 9 g/10 min, and particularly preferably 0.2 to 8 g/10 min. When the melt flow rate of the styrene-based thermoplastic elastomer is in the range of 0.1 to 10 g/10 min, a molded body having sufficient toughness can be obtained.

The content of the elastomer is in the range of 1 to 20% by mass, preferably in the range of 1 to 15% by mass, and more preferably in the range of 1 to 12% by mass, with respect to the total amount of the polycarbonate resin composition. When the content of the elastomer is 2% by mass or more, the effect of adding the elastomer can be obtained. Whereas, when the content of the elastomer is 20% by mass or less, appropriate rigidity and long-term creep resistance can be imparted to the molded body.

In addition, the polycarbonate resin composition of the present invention may include other components as long as the effects of the present invention are not impaired. Examples of other components include antioxidants, UV absorbers, pigments, antistatic agents, copper damage inhibitors, flame retardants, neutralizers, foaming agents, plasticizers, nucleating agents, bubble inhibitors, and cross-linking agents. The content of the other components is preferably 1% by mass or less, and more preferably 0.5% by mass or less, with respect to the total amount of the polycarbonate resin composition.

### 2. Method for Producing Polycarbonate Resin Composition

A method for producing the polycarbonate resin composition will be described. A method for producing the polycarbonate resin composition of the present invention includes: the first step of melt-kneading 2 to 50% by mass of ABS resin (B), 40 to 70% by mass of at least one basic magnesium sulfate (C) selected from fibrous basic magnesium sulfate (C-1) and fan-shaped basic magnesium sulfate (C-2), 0.1 to 5% by mass of at least one (D) selected from a fatty acid metal salt and a fatty acid, and 1 to 50% by mass of elastomer (E) to obtain masterbatch pellets; and the second step of melt-kneading 10 to 60% by mass of the masterbatch pellets and 40 to 90% by mass of polycarbonate resin (A) to produce a polycarbonate resin composition.

In the first step, ABS resin (B), at least one basic magnesium sulfate (C) selected from fibrous basic magnesium sulfate (C-1) and fan-shaped basic magnesium sulfate (C-2), at least one (D) selected from a fatty acid metal salt and a fatty acid, and elastomer (E) are melt-kneaded to obtain a masterbatch pellet containing the elastomer and basic magnesium sulfate.

Kneading these masterbatch pellets with the polycarbonate resin causes the ABS resin and the polycarbonate resin to be mixed and dispersed, and an interface is generated between the ABS resin and basic magnesium sulfate. An attractive force is generated by the interfacial tension and thus the elastomer is localized at the interface, thereby suppressing hydrolysis of the polycarbonate resin.

The melt-kneading method is not particularly limited in both the first step and the second step, and examples thereof include a method using a single-screw extruder, a twin-screw extruder, a Banbury mixer, a kneader, or a kneading roll. The melt-kneading temperature in the first step is preferably 160 to 260° C., and more preferably 180 to 240° C., and that in the second step is preferably 230 to 280° C., and more preferably 240 to 260° C.

Each percentage of “2 to 50% by mass of ABS resin (B), 40 to 70% by mass of at least one basic magnesium sulfate (C) selected from fibrous basic magnesium sulfate (C-1) and fan-shaped basic magnesium sulfate (C-2), 0.1 to 5% by mass of at least one (D) selected from a fatty acid metal salt and a fatty acid, and 1 to 50% by mass of elastomer (E)” in the first step is a percentage in the production of the masterbatch pellet. Adjusting the ratio between the masterbatch pellets produced in the above percentage and polycarbonate resin (A) in the second step can adjust the percentages of ABS resin (B), basic magnesium sulfate (C), at least one (D) selected from a fatty acid metal salt and a fatty acid, and elastomer (E) in the polycarbonate resin composition.

In the first step, the method for obtaining the masterbatch pellets is not particularly limited, and the masterbatch pellets can be obtained by melt-kneading and then by molding into pellets with a known method.

In addition, in the second step, the shape of the polycarbonate resin composition obtained by melt-kneading is not limited, and molding can be performed into any shape such as a strand shape, a sheet shape, a flat plate shape, or a pellet shape. Considering molding in a later step, a pellet shape is preferable from the viewpoint of easy supply to the molding machine.

### 3. Masterbatch (MB) Pellets

Masterbatch pellets will be described below. The masterbatch pellets of the present invention are a raw material for producing a polycarbonate resin composition by kneading with a diluent including polycarbonate resin (A).

The masterbatch pellets of the present invention include 2 to 50% by mass of ABS resin (B), 40 to 70% by mass of at least one basic magnesium sulfate (C) selected from fibrous basic magnesium sulfate (C-1) and fan-shaped basic magnesium sulfate (C-2), 0.1 to 5% by mass of at least one (D) selected from a fatty acid metal salt and a fatty acid, and 1 to 50% by mass of elastomer (E). The masterbatch pellets of the present invention preferably include 2 to 45% by mass of ABS resin (B), 55 to 70% by mass of at least one basic magnesium sulfate (C) selected from fibrous basic magnesium sulfate (C-1) and fan-shaped basic magnesium sulfate (C-2), 0.1 to 4.5% by mass of at least one (D) selected from a fatty acid metal salt and a fatty acid, and 1 to 45% by mass of elastomer (E). The masterbatch pellets of the present invention more preferably include 2 to 40% by mass of ABS resin (B), 60 to 70% by mass of at least one basic magnesium sulfate (C) selected from fibrous basic magnesium sulfate (C-1) and fan-shaped basic magnesium sulfate (C-2), 0.5 to 4% by mass of at least one (D) selected from a fatty acid metal salt and a fatty acid, and 2 to 40% by mass of elastomer (E).

Details of ABS resin (B), basic magnesium sulfate (C), at least one (D) selected from a fatty acid metal salt and a fatty acid, and elastomer (E) are as described above, and thus the description thereof will be omitted. In addition, the method for producing the masterbatch pellets is the same as the first step of the method for producing the polycarbonate resin composition described above. The diluent is not particularly limited as long as it is a resin including polycarbonate resin (A) described above.

### 4. Molded Body

The molded body will be described below. The molded body of the present invention can be produced by molding the polycarbonate resin composition of the present invention. Examples of the method for molding the polycarbonate resin composition include: a method of producing the polycarbonate resin composition by the above method and molding the polycarbonate resin composition; and a method of mixing the masterbatch pellets and the diluted pellets and directly molding the mixture with a molding machine. In addition, examples of the molding machine used for molding include a rolling molding machine such as a calendar molding machine, a vacuum molding machine, an extrusion molding machine, an injection molding machine, a blow molding machine, and a press molding machine.

The molded body of the present invention has an excellent property of high Izod impact strength. The Izod impact strength is an index representing the strength against impact. The value of the Izod impact strength in the present description can be defined as the result measured by the method described in examples described later. Specifically, it is the result of measurement by the method in accordance with JIS K7110 with the Izod impact tester.

Moreover, the molded body of the present invention is also excellent in high flexural modulus. The flexural modulus is an index representing the difficulty of deformation of the molded body, and can be defined as the result measured by the method described in examples described later. Specifically, it is the result of measurement by the method in accordance with JIS K7171 with a universal dynamic testing machine.

The molded body of the present invention is obtained by molding the polycarbonate resin composition that is obtained by using, as a filler, fibrous basic magnesium sulfate having a small average fiber diameter (average minor axis) or fan-shaped basic magnesium sulfate wherein a part of a plurality of fibrous basic magnesium sulfates is connected in a fan shape. Therefore, the molded body of the present invention has an advantage of an excellent appearance as compared with the case where glass fiber having a large average fiber diameter (average minor axis) is used as a filler, and thus usefulness for an exterior portion that is visible to the public.

Hereinafter, the present invention will be specifically described based on examples, but these do not limit the object of the present invention, and the present invention is not limited to these examples.

The measurement method used in the present examples will be shown.

(Melt Flow Rate (MFR))

A melt flow rate test was conducted in accordance with JIS K7210 with a melt flow indexer (G-01, manufactured by Toyo Seiki Seisakusho Co., Ltd.), and the melt flow rate (MFR) was evaluated. The value of MFR is larger, indicating that the processability is better.

(Izod Impact Strength (Izod))

The Izod impact strength was evaluated by conducting a test in accordance with JIS K7110 with an Izod impact tester (manufactured by MYS-TESTER Co., Ltd.). The hammer was 2.75 J.

(Flexural Modulus (FM))

A 3-point bending test was performed by using a universal dynamic testing machine (manufactured by Imada Co., Ltd.), and the flexural modulus was evaluated by a method in accordance with JIS K7171 from the load deflection curve obtained. The distance between the fulcrums was 40 mm, and the load speed was 10 mm/min.

<Production of Resin Composition>

The components used in examples and comparative examples are shown below.

Polycarbonate resin (A):

[MFR (temperature of 240° C., load of 5.000 kg): 4.5 g/10 minutes]

ABS resin (B):

[MFR (temperature of 220° C., load of 5.000 kg): 18 g/10 minutes]

Fibrous basic magnesium sulfate (C-1):

(MOS-HIGE A-1, manufactured by Ube Material Industries Ltd., average major axis: 15 μm, average minor axis: 0.5 μm)

Fan-shaped basic magnesium sulfate (C-2):

(Average particle length of 33.0 μm, average particle width of 6.0 μm, average aspect ratio of 5.5)

Fatty acid metal salt (D): magnesium stearate

Elastomer (E): styrene-ethylene/butylene-styrene (SEBS, Tough Tech H1043, manufactured by Asahi Kasei Corporation)

Glass fiber (F):

Chopped GF (ECS03 T-511, manufactured by Nippon Electric Glass Co., Ltd., fiber major diameter: 3 mm, fiber minor diameter: 13 μm)

Milled GF (PF E-001, manufactured by Nitto Boseki Co., Ltd., fiber minor diameter: 10 μm)

### Example 1

25.3% by mass of ABS resin (B), 59.1% by mass of fibrous basic magnesium sulfate particles (C-1), 1.8% by mass of fatty acid metal salt (D), and 13.8% by mass of elastomer (E) were mixed, and the resulting mixture was melt-kneaded at 240° C. for 2 minutes. For melt-kneading, a melt-kneading extruder, Labplast Mill Roller Mixer (R60, capacity of 60cc, manufactured by Toyo Seiki Co., Ltd.) was used, and the rotation speed of the shaft was 120 rpm. The obtained melt-kneaded product was formed into a sheet by hot pressing (temperature of 240° C.) and then cut to provide masterbatch pellets.

24.7% by mass of the masterbatch pellets and 75.3% by mass of the polycarbonate resin (A) were mixed. Then, a twin-screw melt-kneading extruder (L/D=25, manufactured by Imoto Machinery Co., Ltd.) was used to perform melt-kneading at 260° C. and 50 rpm to obtain the polycarbonate resin composition in Example 1.

### Example 2

Masterbatch pellets were obtained in the same manner as in Example 1, except that 22.8% by mass of ABS resin (B), 53.1% by mass of fibrous basic magnesium sulfate particles (C-1), 1.6% by mass of fatty acid metal salt (D), and 22.5% by mass of elastomer (E) were used.

The polycarbonate resin composition in Example 2 was obtained in the same manner as in Example 1, except that 27.5% by mass of the masterbatch pellets and 72.5% by mass of polycarbonate resin (A) were used.

### Example 3

Masterbatch pellets were obtained in the same manner as in Example 1, except that 19.7% by mass of ABS resin (B), 46.2% by mass of fibrous basic magnesium sulfate particles (C-1), 1.4% by mass of fatty acid metal salt (D), and 32.7% by mass of elastomer (E) were used.

The polycarbonate resin composition in Example 3 was obtained in the same manner as in Example 1, except that 31.8% by mass of the masterbatch pellets and 68.2% by mass of polycarbonate resin (A) were used.

### Example 4

Masterbatch pellets were obtained in the same manner as in Example 1, except that 25.3% by mass of ABS resin (B), 59.1% by mass of fan-shaped basic magnesium sulfate particles (C-2), 1.8% by mass of fatty acid metal salt (D), and 13.8% by mass of elastomer (E) were used.

The polycarbonate resin composition in Example 4 was obtained in the same manner as in Example 1, except that 24.7% by mass of the masterbatch pellets and 75.3% by mass of polycarbonate resin (A) were used.

### Example 5

The polycarbonate resin composition in Example 5 was obtained in the same manner as in Example 1, except that 22.8% by mass of ABS resin (B), 53.1% by mass of fan-shaped basic magnesium sulfate particles (C-2), 1.6% by mass of fatty acid metal salt (D), and 22.5% by mass of elastomer (E) were used to produce masterbatch pellets, and 27.5% by mass of the masterbatch pellets obtained and 72.5% by mass of polycarbonate resin (A) were mixed.

### Example 6

The polycarbonate resin composition in Example 6 was obtained in the same manner as in Example 1, except that 19.7% by mass of ABS resin (B), 46.2% by mass of fan-shaped basic magnesium sulfate particles (C-2), 1.4% by mass of fatty acid metal salt (D), and 32.7% by mass of elastomer (E) were used to produce masterbatch pellets, and 31.8% by mass of the masterbatch pellets obtained and 68.2% by mass of polycarbonate resin (A) were mixed.

### Comparative Example 1

Masterbatch pellets were obtained in the same manner as in Example 1, except that 27.3% by mass of ABS resin (B), 64.2% by mass of fibrous basic magnesium sulfate particles (C-1), 1.9% by mass of fatty acid metal salt (D), and 6.6% by mass of elastomer (E) were used.

The polycarbonate resin composition in Comparative Example 1 was obtained in the same manner as in Example 1, except that 22.9% by mass of the masterbatch pellets obtained and 77.1% by mass of polycarbonate resin (A) were used.

### Comparative Example 2

Polycarbonate resin (A) was used singly.

### Comparative Example 3

80% by mass of polycarbonate resin (A) and 20% by mass of glass fiber (F) (Chopped GF) were mixed. The obtained mixture was melt-kneaded with a twin-screw melt-kneading extruder to obtain the polycarbonate resin composition in Comparative Example 2. Melt-kneading was performed in the same manner as in Example 1 except that the temperature was changed to 280° C.

### Comparative Example 4

80% by mass of polycarbonate resin (A) and 20% by mass of fibrous basic magnesium sulfate particles (C-1) were mixed. Then, as in Example 1, melt-kneading was attempted with a twin-screw melt-kneading extruder; however, kneading failed.

### Comparative Example 5

84.7% by mass of polycarbonate resin (A), 14.9% by mass of fibrous basic magnesium sulfate particles (C-1), and 0.4% by mass of fatty acid metal salt (D) were mixed. Then, as in Example 1, melt-kneading was attempted with a twin-screw melt-kneading extruder; however, kneading failed.

### Comparative Example 6

79.0% by mass of polycarbonate resin (A), 6.3% by mass of ABS resin (B), and 14.7% by mass of fibrous basic magnesium sulfate particles (C-1) were mixed. Then, as in Example 1, melt-kneading was attempted with a twin-screw melt-kneading extruder; however, kneading failed.

It is found from the results of Comparative Examples 4 to 6 that kneading itself is impossible when the fibrous basic magnesium sulfate particles (C-1) are contained and ABS resin (B) and/or fatty acid metal salt (D) are not included.

### Comparative Example 7

The polycarbonate resin composition in Comparative Example 7 was obtained in the same manner as in Example 3, except that fibrous basic magnesium sulfate particles (C-1) were changed to the same amount of glass fiber (F) (Chopped GF).

### Comparative Example 8

The polycarbonate resin composition in Comparative Example 8 was obtained in the same manner as in Example 3, except that fibrous basic magnesium sulfate particles (C-1) were changed to the same amount of glass fiber (F) (Milled GF).

### Comparative Example 9

27.3% by mass of ABS resin (B), 64.2% by mass of fan-shaped basic magnesium sulfate particles (C-2), 1.9% by mass of magnesium stearate (D), and 6.6% by mass of elastomer (E) were used to produce masterbatch pellets, and kneading was attempted in the same manner as in Comparative Example 1 except that 22.9% by mass of the masterbatch pellets obtained and 77.1% by mass of polycarbonate resin (A) were mixed; however, kneading failed.

Table 1 below summarizes the contents (% by mass) of polycarbonate resin (A), ABS resin (B), basic magnesium sulfate particles (C), fatty acid metal salt (D), elastomer (E), and glass fiber (F) in the polycarbonate resin compositions obtained in Examples 1 to 6 and Comparative Examples 1 to 9.

TABLE 1

| | | | (C) | | | | |
|---|---|---|---|---|---|---|---|
| | (A) | (B) | (C-1) | (C-2) | (D) | (E) | (F) |
| Example 1 | 75.3 | 6.26 | 14.6 | | 0.44 | 3.4 | |
| Example 2 | 72.5 | 6.26 | 14.6 | | 0.44 | 6.2 | |
| Example 3 | 68.2 | 6.26 | 14.7 | | 0.44 | 10.4 | |
| Example 4 | 75.3 | 6.26 | | 14.6 | 0.44 | 3.4 | |
| Example 5 | 72.5 | 6.26 | | 14.6 | 0.44 | 6.2 | |
| Example 6 | 68.2 | 6.26 | | 14.7 | 0.44 | 10.4 | |
| Comparative Example 1 | 77.1 | 6.26 | 14.7 | | 0.44 | 1.5 | |
| Comparative Example 2 | 100.0 | | | | | | |
| Comparative Example 3 | 80.0 | | | | | | 20.0 |
| Comparative Example 4 | 80.0 | | 20.0 | | | | |
| Comparative Example 5 | 84.7 | | 14.9 | | 0.4 | | |
| Comparative Example 6 | 79.0 | 6.3 | 14.7 | | | | |
| Comparative Example 7 | 68.2 | 6.26 | | | 0.44 | 10.4 | 14.7 |
| Comparative Example 8 | 68.2 | 6.26 | | | 0.44 | 10.4 | 14.7 |
| Comparative Example 9 | 77.1 | 6.26 | 14.7 | | 0.44 | 1.5 | |

<Evaluation Method>

The polycarbonate resin compositions obtained in Examples 1 to 6 and Comparative Examples 1 to 9 were extruded into strand-shaped ones and then cut to obtain polycarbonate resin composition pellets. For the polycarbonate resin composition pellets, the melt flow rate was measured by the above method.

In addition, the above polycarbonate resin composition pellets were injection-molded by a small injection molding machine (C. Mobile0813, manufactured by Shinko Sellbic Co., Ltd.) to produce a molded body (length of 50 mm, width of 5 mm, thickness of 2 mm). Using the obtained molded body as a test piece, the impact strength, flexural modulus, and the strength were measured by the method described above.

Moreover, the appearance of each test piece was visually observed to check whether or not a filler was recognized on the surface. The case where the filler was not recognized was designated as “O”, and the case where the filler was recognized was designated as “X”.

The obtained results are summarized in Table 2 below together with the above measurement results.

TABLE 2

| | | Impact | | |
|---|---|---|---|---|
| | MFR | resistance | FM | |
| | (g/10 min) | Izod (kJ/m²) | (GPa) | Appearance |
| Example 1 | 13.8 | 20.3 | 4.25 | ○ |
| Example 2 | 16.7 | 13.7 | 4.31 | ○ |
| Example 3 | 21.3 | 18.6 | 4.38 | ○ |
| Example 4 | 10.5 | 23.3 | 3.91 | ○ |
| Example 5 | 9.2 | 10.7 | 3.70 | ○ |
| Example 6 | 10.2 | 9.2 | 3.69 | ○ |
| Comparative Example 1 | 45.8 | 1.3 | 4.59 | ○ |
| Comparative Example 2 | 4.5 | 87.8 | 2.16 | ○ |
| Comparative Example 3 | 4.1 | 11.8 | 4.83 | × |
| Comparative Example 7 | 34.3 | 2.9 | 3.60 | × |
| Comparative Example 8 | 25.2 | 1.9 | 2.70 | ○ |

As shown in Table 2 above, the polycarbonate resin compositions (Examples 1 to 3) containing polycarbonate resin, ABS polymer, fibrous basic magnesium sulfate, fatty acid metal salt, and elastomer in a predetermined amount have significantly improved values of the melt flow rate, as compared with the polycarbonate resin singly (Comparative Example 2) and the polycarbonate resin composition including only glass fiber (Comparative Example 3).

A molded body produced by using the polycarbonate resin composition in Examples 1 to 6 is excellent in impact resistance (Izod) and flexural modulus (FM), and also has a good appearance. Whereas, a molded body produced by using a polycarbonate resin composition in which the content of elastomer was small (Comparative Example 1) has poor impact resistance (Izod), and a molded body produced by using a polycarbonate resin singly (Comparative Example 2) has a small flexural modulus (FM).

In addition, as shown in Comparative Examples 7 and 8, a molded body produced by using a polycarbonate resin composition containing glass fiber instead of fibrous basic magnesium sulfate is poor in impact resistance (Izod) and flexural modulus (FM). When chopped GF is used as a filler, defects occur in the appearance of a resulting molded body (Comparative Examples 3 and 7).

In Comparative Example 9 in which the content of the elastomer (E) was small, the polycarbonate resin was hydrolyzed by fan-shaped basic magnesium sulfate, and kneading failed.

It was shown that the polycarbonate resin composition containing polycarbonate resin, ABS polymer, basic magnesium sulfate, fatty acid metal salt, and elastomer in predetermined amounts can be kneaded and molded without hydrolysis, has excellent processability, and can provide a molded body having a good mechanical properties and appearance.

1. A polycarbonate resin composition comprising: 50 to 90% by mass of polycarbonate resin (A); 2 to 30% by mass of acrylonitrile-butadiene-styrene copolymer resin (B); 5 to 40% by mass of at least one basic magnesium sulfate (C) selected from fibrous basic magnesium sulfate (C-1) and fan-shaped basic magnesium sulfate (C-2); 0.1 to 8% by mass of at least one (D) selected from a fatty acid metal salt and a fatty acid; and 1 to 20% by mass of elastomer (E).

2. A method for producing a polycarbonate resin composition, the method comprising:
a first step of melt-kneading 2 to 50% by mass of acrylonitrile-butadiene-styrene copolymer resin (B), 40 to 70% by mass of at least one basic magnesium sulfate (C) selected from fibrous basic magnesium sulfate (C-1) and fan-shaped basic magnesium sulfate (C-2), 0.1 to 5% by mass of at least one (D) selected from a fatty acid metal salt and a fatty acid, and 1 to 50% by mass of elastomer (E) to obtain masterbatch pellets; and
a second step of melt-kneading 10 to 60% by mass of the masterbatch pellets and 40 to 90% by mass of polycarbonate resin (A) to produce the polycarbonate resin composition.

3. Masterbatch pellets for producing a polycarbonate resin composition by kneading with a diluent comprising polycarbonate resin (A),
the masterbatch pellets comprising: 2 to 50% by mass of acrylonitrile-butadiene-styrene copolymer resin (B); 40 to 70% by mass of at least one basic magnesium sulfate (C) selected from fibrous basic magnesium sulfate (C-1) and fan-shaped basic magnesium sulfate (C-2); 0.1 to 5% by mass of at least one (D) selected from a fatty acid metal salt and a fatty acid; and 1 to 50% by mass of elastomer (E).

4. A molded body, being a molded product of the polycarbonate resin composition according to claim 1.
